(19) United States
(12) Patent Application Publication
(10) Pub. No.: US 2026/0192311 A1
(43) Pub. Date: Jul. 9, 2026

(54) SPRAYER UNIT, OUTLET COMPRISING A SPRAYER UNIT, AND METHOD FOR OPERATING THE SPRAYER UNIT

(71) Applicant: L'OREAL, PARIS (FR)

(72) Inventors: Fanny LUDER, Biel/Bienne (CH); Caroline JACKSON, Biel/Bienne (CH); Alexis MARETTE, Biel/Bienne (CH); Florence LOUIS, Biel/Bienne (CH)

(21) Appl. No.: 19/512,266

(22) PCT Filed: Aug. 29, 2024
(86) PCT No.: PCT/EP2024/074166

§ 371 Date: Feb. 18, 2026

(30) Foreign Application Priority Data
Sep. 4, 2023 (CH) 000954/2023
Apr. 23, 2024 (CH) 000439/2024

(51) Int. Cl. B05B 1/26; B05B 1/18

(52) U.S. Cl. CPC B05B 1/26; B05B 1/182

(57) ABSTRACT

An Outlet is provided having an outlet body with a conduit leading from a supply section to a connection section, and at least two sprayer units attached to the connection section, each sprayer unit having a set of sprayers, each sprayer with a set of at least two nozzles arranged to create colliding jets of the liquid and thereby creating a spray of droplets of the liquid. The number of sprayers in the set of sprayers is at least two.

The invention relates to a sprayer unit, for use in an outlet for spraying a liquid such as water or a water-based mixture, for example in a washing installation as used in the field of domestic plumbing installations.

WO 2004/101163 A1 (Methven) discloses a showerhead with a large number of nozzle pairs, each nozzle pair creating impinging jets of water with the goal of creating a spray of water. The showerhead is supposed to operate well over a range of pressures, 25-1000 kPa, that is, from 0.25 to 10 bar. However, there is no disclosure which physical dimensions correspond to a particular pressure or pressure range. The exit aperture of the nozzles is between 0.8 and one millimetre. The nozzles are formed between two plates placed against one another. The nozzles are oriented to have an included angle between 40° and 140°. The nozzles of a nozzle pair are arranged to collide with 20% to 80% crossover, that is, they are designed to be misaligned. Given the nozzle dimensions and number of nozzles, the total flow rate is relatively high.

BE 514104A discloses a spray head with colliding water jets created by four inclined holes in in a flat plate, at an angle of 45°. The thickness of the plate is 1 to 5 mm. The diameter of the holes is said to be smaller than nozzle 12 mm.

U.S. Pat. No. 2,744,738 discloses an aerator with colliding water jets, including flow guiding elements after the point of collision.

U.S. Pat. No. 8,458,826 discloses an outlet for a shower or tap wherein water is dispensed at a low flow rate and at a high pressure, typically more than 10 bar, through impinging jets. As opposed to WO 2004/101163 A1 cited above, only one or two nozzle pairs are sufficient for an outlet in a showerhead. A good washing experience, that is, a feeling of a full water flow and good rinsing in spite of the low flow rate, is obtained by atomisation of the water by means of the colliding jets, which in turn is a result of the high pressure.

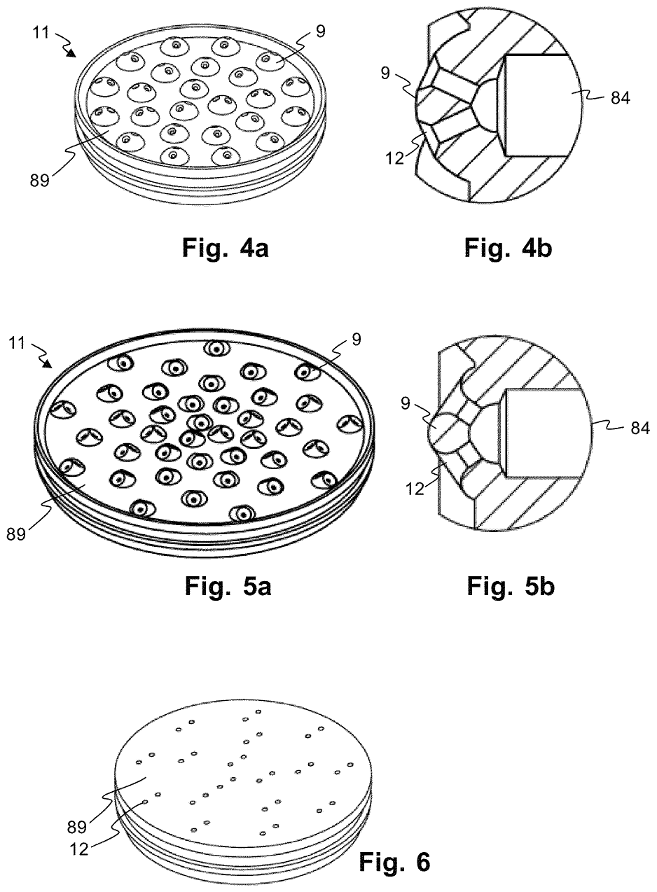

WO 2011/054120 A1 discloses, for example in embodiments according to FIGS. 4 to 6 and FIGS. 20 to 23, cartridges for generating a spray of a liquid, such as water or water-based mixture, from colliding jets. Such cartridges can be integrated units for atomising and spraying such a liquid a water-based mixture, by means of impinging jets of the liquid under high pressure.

WO 2019/233958 A1 discloses a cartridge for use in a showerhead or tap, comprising a set of at least two nozzles arranged to create colliding jets of the liquid and thereby create a spray of droplets of the liquid, and a spray shaper for guiding the spray. The spray shaper can have the form of a hollow cylinder.
A nozzle diameter is disclosed to be from 0.8 to 1.5 or 2 millimetres, preferably approximately 1.3 millimetres.
An angle between longitudinal axes of the nozzles is 90°+/−20°.
A distance between a collision point of the jets and a front surface (which is approximately equal to the length of the spray shaper) is more than 14 or 17 or 20 millimetres, and in particular less than 30 or 25 or 22 millimetres.
A maximum distance between spray shaper back end and the front surface is more than 18 or 21 or 24 millimetres, and in particular less than 33 or 28 or 25 millimetres.
An inner diameter of spray shaper is 10 to 18 millimetres, preferably 14 millimetres.

WO 2019/233958 A1 discloses the operating principles of generating a spray of a liquid by impinging jets and of forming the spray by means of the spray shaper, and is herewith incorporated in its entirety by reference.

Effects of such sprays generated with impinging jets include a good wetting and rinsing of surfaces, due to the presence of small droplets, and an agreeable washing experience in the case of a shower or tap. These effects are combined with a reduced use of water.

There is a need to realise such effects in a wider range of operating conditions, and/or to increase the versatility of sprayers using impinging jets, and/or to increase water savings compared to existing outlets.

The following terms shall be used: An outlet comprises one or more atomisers. An atomiser comprises, for example, a nozzle set with two or more nozzles for creating impinging jets of water. As opposed to sprayers ordinarily used in showers, an atomiser generates a flow of a mixture of air and microscopic water droplets rather than macroscopic drops. An outlet can be a part of a tap, or can be a shower head attached to a handle, or a shower head fixedly installed at the end of a pipe or sunk in a wall. An outlet thus is a unit that can be transported, handled and installed as a single unit, in contrast to a shower installation: A shower installation may comprise more than one shower heads, arranged, for example, at the top of and in side walls of a shower cabin, with additional plumbing providing the shower heads with pressurised water.

It is a possible object of the invention to provide a sprayer unit that is more versatile with regard to its application and/or range of operating conditions and/or water savings, and a corresponding outlet comprising a sprayer, in particular for use in a washing device in a domestic plumbing installation or in a portable shower or hand washing unit. A further possible object is to provide a method for operating the sprayer unit. A further possible object is to provide a sprayer unit with improved acoustical properties, in particular generating less noise.

At least some of these objects are achieved by a sprayer unit and an outlet comprising a sprayer according to the corresponding claims, and a method for operating the sprayer unit, and an aerator unit.

According to a first aspect, a sprayer unit, a method for operating the sprayer unit, and an outlet comprising a sprayer unit is provided. They allow, among others, to generate a finely atomised spray, even at low pressures.

According to a second aspect, an aerator unit for use in an outlet is provided. They allow to generate a finely atomised spray in a water tap or similar outlet.

According to a third aspect, a sprayer unit is provided, that has improved acoustical properties compared to existing sprayers using colliding jets of liquid.

Sprayer units with parameters as described for the first aspect can be used in an aerator unit as described for the second aspect

Sprayer units with parameters as described for the first and second aspects can be used in combination with a laterally wider section as described for the third aspect.

The sprayer unit according to the first aspect is designed for use in an outlet, in particular in showerhead or tap, for dispensing a liquid, in particular water or a water-based mixture. The sprayer unit comprises a set of sprayers,
each sprayer comprising a set of at least two, in particular exactly two, nozzles arranged to create colliding jets of the liquid and thereby create a spray of droplets of the liquid, and
wherein the number of the sprayers in the set of sprayers is at least three,
wherein the sprayers of the set of sprayers are formed as a single part or are assembled from two or more separate parts.

In embodiments, part or preferably all sprayers comprise an associated spray shaper for guiding the spray, the spray shaper being a cavity through which the spray passes before exiting the sprayer unit. So, there is preferably a one-to one correspondence between the sprayers and the spray shapers. Typically, the cavity is empty, that is, it is free from internal obstacles that would otherwise affect the spray apart from a peripheral lateral wall for shaping said spray.

The nozzles have longitudinal axes, coaxial with the jets generated by the nozzles. A set of nozzles generates a spray that has a longitudinal axis or spray axis, which is the main direction of the spray. It usually also is the axis bisecting the axes of the nozzles, and shall also be called the longitudinal axis of the sprayer. Typically, the spray shaper is arranged with its longitudinal axis, which usually also is its axis of symmetry, to coincide with the spray axis and thus the longitudinal axis of the sprayer. The complete sprayer unit has a main longitudinal axis, which is a longitudinal axis of the combined spray that is generated by the entirety of sprayers of the sprayer unit. The longitudinal axes of the sprayers can be all parallel to the main longitudinal axis, or at least some of them can be at an angle to the main longitudinal axis.

In embodiments, the sprayers of the set of sprayers are not formed as a single part. That is, they are formed or assembled from two or more separate parts. In this case they can be inseparably attached to one another, for example, by welding or bonding (glueing). Or they can be separably attached to one another, that is, they are designed to be disassembled and reassembled. In other words, the sprayer unit is not formed as a single part.

Compared to sprayers in known outlets, the number of sprayers is relatively high and the dimensions of the individual sprayers are much smaller. This allows for a number of effects, compared to known sprayers:

The sprayers can be operated at a lower pressure, e.g. around one bar or even less. The flow rate for each sprayer is lower, but the combination of multiple sprayers achieves a required total flow rate.

Given this ability to operate at lower pressures, the design and manufacturing process for a sprayer unit operating at a particular pressure, such as approximately one bar, can be optimised for mass production. The sprayer unit can be used over a large range of pressures by combining it with a pressure reducing element.

Dividing the flow over multiple sprayers can be used to approximate the feel of a traditional shower, while keeping the water-saving advantage of the impinging jets.

Furthermore, since the individual sprayers can be made smaller, and in particular their spray shapers can be made shorter, the thickness of the entire sprayer unit can be made smaller than existing solution. This gives more freedom when designing an outlet, e.g. a showerhead.

The general shape of the sprayer unit can be that of a flat plate, preferably with parallel front and back surfaces. The sprayers are arranged to guide liquid from the side with the back surface through the sprayer unit to the side with the front surface.

In embodiments, the sprayer unit has the shape of a bent plate, preferably with parallel front and back surfaces. In embodiments, one of the front and back surfaces of the plates is flat, and the other one has a convex or a concave shape.

Depending on the requirements of a specific purpose, the characteristics of a sprayer unit can be tailored by varying the number of sprayers and their individual characteristics. The design, using a plurality of small sprayers rather than a single sprayer, allows for a greater variability of the properties of the combined set of sprayers, implemented by the sprayer unit. For example, the sprayers can be optimised for a given water pressure, and the number of sprayers can be chosen according to a desired total flow rat.

In embodiments, the number of the sprayers in the set of sprayers is at least five, in particular at least ten, in particular at least fifteen.

This allows to realise a required combined flow rate for the sprayer unit.

In embodiments, a diameter of the sprayer unit is less than fifteen centimetres, in particular less than ten centimetres, in particular less than five centimetres, in particular less than three centimetres.

This allows to realise a relatively small sprayer unit comprising multiple sprayers. This is turn allows to implement an agreeable spray at a high flow rate in a small unit with low design constraints on an outlet in which it is installed.

In embodiments, the sprayers of the set of sprayers are formed as a single part, in particular as a single part of a plastic material. In other words, the sprayer unit is formed as a single part. Such a single part can comprise several components moulded together. In embodiments, the part comprises or is formed of a metal material.

This allows them to be mass produced by simple means. It further eliminates the necessity to assemble multiple sprayers that are to be used in an outlet. The nozzles can be shaped in the process of moulding the sprayer unit, or they can be created later, in the moulded sprayer unit.

In embodiments, the multiple sprayers have the same dimensions. This causes them to have the same spraying characteristics and an equal distribution of the liquid over the multiple sprayers.

In embodiments, the multiple sprayers are oriented in the same direction. This allows to focus the combined spray in a given direction. This is useful in, for example, professional hair care applications, where the combined spray should be focused on a client's scalp, and spraying or splashing other regions should be avoided.

In embodiments, in each of the sprayers the nozzles of the sprayer are arranged in a dome shaped structure covering the spray shaper of the sprayer, with an inner surface of the dome shaped structure having a smaller diameter than the spray shaper, in particular wherein the inner surface of the dome shaped structure has a diameter of less than 80% of the diameter of the spray shaper.

In embodiments, in each of the sprayers a distance between a point at which the jets collide and an outlet opening of the spray shaper, this distance to be called length of the spray shaper Ls, lies between three and twenty millimetres, in particular between three and ten millimetres, in particular between three and seven millimetres, in particular between four and five millimetres.

In embodiments, in each of the sprayers an inner diameter Ds of the spray shaper lies between one and a half and fourteen millimetres, in particular between two and eight millimetres, in particular between two and four millimetres.

The aspect ratio between the length and inner diameter of the spray shaper can be made relatively large, e.g. with the length being two times the inner diameter, or even longer. Such high aspect ratios result in a relatively focused spray, as opposed to a spray that widens quickly. This is particularly advantageous in professional hair care applications. Experiments have shown that in such applications, the bouncing of droplets off the scalp and hair is smaller than with less focused and larger sprayers.

Because the absolute dimensions of the individual spray shapers can be chosen to be relatively small, the aspect ratio can be realised with a relatively small length of the spray shaper and thus of the entire sprayer and sprayer unit. The required total flow rate is achieved by the combination of multiple sprayers.

Since the absolute dimensions of the individual spray shapers are relatively small, the distance from the exit of each nozzle to the collision point of the colliding jets is smaller. This makes it easier to align the jets to meet precisely, and thus allows for lower manufacturing tolerances.

In embodiments, in each of the sprayers the diameter D2 of the nozzles lies between 0.3 and 1.2 millimetres, in particular between 0.5 and 0.6 millimetres.

In embodiments, the shape of the nozzles is such that with the liquid provided to the sprayer unit with a pressure between 0.5 bar and 1.5 bar or 2 bar or 3 bar, in particular of at least approximately one bar, and flow rate of between 0.1 and 0.4 litres per minute in each sprayer results. In embodiments, the number of sprayers is such that given this pressure a total flow rate is between one and ten litres per minute, in particular between three and six litres per minute, in particular at least approximately 4 litres per minute.

In embodiments, in each of the sprayers a half-angle α between colliding jets lies between 15 and 45 degrees, in particular between 20 and 35 degrees, in particular between 25 and 30 degrees.

Such a relatively small angle has the effect of directing the spray generated by the impinging jets forward, in the direction of the outlet of the spray shaper. This gives a better efficiency in creating the droplets, compared to larger angles.

In embodiments, in each of the sprayers a ratio or aspect ratio between the length and the diameter of the spray shaper lies between ten to seven and two to one. Preferably it is at least approximately two to one.

In embodiments, in each of the sprayers the number of nozzles lies between two and five. In particular it is two or four.

In embodiments, the nozzles are directed so that the jets of water overlap one another as well as possible, that is, with a 100% overlap. This maximises the efficiency of generating the spray by the impinging jets.

In embodiments, regardless of the number and arrangement of sprayers, the sprayers have the following parameters:
the diameter of the nozzles is between 0.4 mm and 0.6 mm, preferably 0.6 mm;
the half angle between nozzles is between 25° and 45°; preferably 35°;
the diameter of the spray shaper is between 2 mm and 3 mm, preferably 2.5 mm;
the length of the spray shaper is between 4 mm and 6 mm, preferably 5 mm.

Typically, these parameters are for sprayers with exactly two nozzles.

In embodiments, these parameters are for sprayers with exactly four nozzles.

In embodiments,
the number of sprayers in the set of sprayers is between 15 and 25, in particular 17;
a diameter D of the sprayer unit is between 25 mm and 35 mm, in particular 33 mm.

In embodiments,
the number of sprayers in the set of sprayers is between 40 and 80, in particular between 50 and 70, in particular 60;
and a diameter D of the sprayer unit is between 120 mm and 200 mm, in particular between 140 mm and 160 mm.

In embodiments, the sprayer unit is free from solid parts that affect the spray after a point at which the colliding jets collide.

It is understood that in “after a point at which the colliding jets collide”, the “after” is meant as seen in a direction of flow of the liquid.

Thus, the sprayer unit does not comprise a spray shaper. As opposed to embodiments that do have a spray shaper, in embodiments without a spray shaper a directionality of the spray can be achieved by a relatively small half angle. leading to a larger impulse of the spray in the direction of its axis.

In embodiments, the sprayer unit has at least one of the following parameters:
diameter D of the sprayer unit: between 10 and 50 mm, in particular between 10 and 30 mm, in particular between 25 and 35 mm;
number of sprayers in the sprayer unit: between 5 and 30, in particular between 10 and 20.

In embodiments, the sprayer unit has at least one of the following parameters:
diameter D of the sprayer unit: between 5 and 200 mm, in particular between 10 and 100 mm, in particular between 25 and 50 mm;
number of sprayers in the sprayer unit: between 3 and 50, in particular between 5 and 30, in particular between 10 and 20.

In embodiments, the sprayer unit has at least one of the following parameters:
nozzle diameter D2 of the sprayers: between 0.4 and 1 mm, in particular between 0.6 and 0.8 mm;
half-angle α between nozzles: between 5° and 55°, in particular between 15° and 35°, in particular at least approximately 25°.

In embodiments, at least sprayers at the periphery of the sprayer unit are angled, with an offset angle β relative to a main longitudinal axis of the sprayer unit, so that the longitudinal axes of these sprayers diverge from the main longitudinal axis,
in particular wherein the offset angle β is between 2° or 4° and 10°, in particular between 5° and 7°, in particular at least approximately 6°,

Having such angled sprayers without spray shapers allows them to be manufactured more easily than would be the case if angled spray shapers were present.

In embodiments, the sprayer unit comprises a plurality of sprayers arranged to form a ring of sprayers, and so close to one another that recesses, into which the nozzles of each sprayer lead, combine to form a circular groove in the front surface of the sprayer unit.

In embodiments, the sprayer unit has at least one of the following parameters:
diameter D of the sprayer unit: between 10 and 50 mm, in particular between 10 and 30 mm, in particular between 25 and 35 mm;
number of sprayers in the sprayer unit: between 5 and 30, in particular between 10 and 20;
diameter of the ring of sprayers: between 10 and 25 mm, in particular between 12 and 20 mm, in particular between 14 and 18 mm.

In embodiments, the sprayer unit has at least one of the following parameters:
nozzle diameter D2 of the sprayers: between 0.2 and 0.8 mm, in particular between 0.4 and 0.6 mm;
half-angle α between nozzles: between 15° and 50°, in particular between 30° and 40°, in particular at least approximately 35°.

The method according to the first aspect is for operating the sprayer unit, for dispensing a liquid, in particular water or a water-based mixture. The method comprises the steps of providing the liquid to the sprayer unit with a pressure between 0.5 bar and 1.5 bar or 2 bar or 3 bar, in particular of at least approximately one bar, and with a resulting flow rate of between 0.1 and 0.4 litres per minute in each sprayer. In particular, the flow rate can be at least approximately 0.1 litres per minute at a pressure of 0.5 bar.

In embodiments, for each of the sprayers, the spray shaper, at an outer end of the spray shaper opposite to the spray shaper back end, ends with a flow guiding edge forming an acute angle between an inner surface of the spray shaper and an adjacent, intermediate surface, in particular an angle of less than 85° or less than 80° or less than 75°.

A method for operating the sprayer unit in an outlet, for example, a showerhead or tap, for dispensing a liquid, in particular water or a water-based mixture, comprises the steps of providing the liquid to the sprayer unit with a pressure between 0.5 bar and 1.5 bar or 2 bar or 3 bar, in particular of at least approximately one bar, and with a resulting flow rate of between 0.1 and 0.4 litres per minute in each sprayer. The total flow rate for a sprayer unit can be between 1.5 and 6 litres per minute. In a typical embodiment, for a pressure of one bar the total flow rate is between 3 and 6, in particular at least approximately 4 litres per minute.

In embodiments, the method comprises delivering the water to the outlet at a pressure of more than one bar, reducing the pressure by means of a pressure reducer to a pressure between 0.5 and 1.5 bar or 2 bar or 3 bar, in particular to a pressure of at least approximately one bar, and dispensing the water through the sprayer unit at a flow rate between 1.5 and 6 litres per minute.

Outlet, in particular a showerhead or tap, comprising the sprayer unit of one claims 1 to 24, comprising an outlet body with a conduit leading from an outlet supply section to a sprayer unit connection section at which the sprayer unit is attached.

In embodiments, the outlet comprises at least two sprayer units, each with a set of sprayers, with the sprayer units each having at least one of the following parameters:
diameter D of the sprayer unit: between 10 and 50 mm, in particular between 15 and 35 mm, in particular between 20 and 30 mm;
number of sprayers of the sprayer unit: between 3 and 20, in particular between 4 and 10.

Such a configuration allows to retrofit existing showerheads or showerhead designs with minimal changes to the design. Moreover, the use of multiple sprayer units allows to implement a desired total number of sprayers while avoiding forces that would arise due to water pressure acting on a single, larger, sprayer unit with the same total number of sprayers sprayer. Furthermore, it allows to mass-produce such smaller sprayer units at high precision and to use them various different designs.

In embodiments, the sprayer units each have at least one of the following parameters:
nozzle diameter D2: between 0.2 and 0.8 mm, in particular between 0.4 and 0.5 mm;
half-angle α between nozzles: between 15° and 50°, in particular between 25° and 35°, in particular at least approximately 30°.

In embodiments, the sprayer units have different parameters. For example, a central sprayer unit can have parameters that differ from the parameters of peripheral sprayer units. In embodiments, the separate sprayer units are provided with water each by an associated conduit of an internal water distribution system of the outlet. In embodiments, one or more of such conduits can be turned on and off, allowing to selectively use one or more but not all of the sprayer units at the same time.

In embodiments, the sprayer unit comprises attachment elements, in particular an external or an internal thread, for attaching it to a water outlet, in particular a tap or showerhead. This makes it possible to provide a unit that can be used to replace existing tap or faucet aerators. The unit can further comprise a seating for a flow limiter or pressure reducer, that is, a space within the unit shaped to receive a pressure reducer. In embodiments, a pressure reducer is present as part of the sprayer unit. It reduces a supply pressure to a standard operating pressure of the sprayer unit. As a result, the flow rate through the sprayer unit is largely independent of the supply pressure.

In embodiments, the sprayer unit comprises a macro spray shaper arranged to shape a combined spray of the sprayers of the sprayer unit. That is, the combined spray is guided and shaped by a cavity, to be called macro spray shaper. The macro spray shaper can be a cylindrical volume, or another shape that confines and/or directs the spray generated by the colliding jets. This makes it possible to shape the combined spray as a whole. Typically, the cavity is empty, that is, it is free from inner obstacles that would otherwise affect the spray apart from a peripheral lateral wall defining said cavity.

The outlet can be a showerhead or tap. The outlet comprises the sprayer unit, and an outlet body with a conduit leading from an outlet supply section to a sprayer unit connection section at which the sprayer unit is attached.

The Aerator unit according to the second aspect is for use in an outlet, in particular in showerhead or tap, for dispensing a liquid, in particular water or a water-based mixture, comprising one or more sprayers, each sprayer comprising a set of at least two, in particular exactly two, nozzles arranged to create colliding jets of the liquid and thereby create a spray of droplets of the liquid.

In embodiments, the aerator unit comprises a seating for a gasket.

In embodiments, the aerator unit comprises a pressure reducer for reducing a supply pressure to a standard operating pressure of the one or more sprayers.

In embodiments, the aerator unit comprises attachment elements, in particular an external or an internal thread, for attaching it to a water outlet, in particular a tap or showerhead.

In embodiments, the aerator unit comprises is designed to be used as an insert in a sleeve, the sleeve comprising attachment elements, in particular an external or an internal thread, for attaching it to a water outlet, in particular a tap or showerhead.

In embodiments, the aerator unit comprises a set of sprayers, wherein the number of the sprayers in the set of sprayers is between 2 and 15, in particular between 5 and 9, in particular 7.

In embodiments, the aerator unit has one or more of the following parameters:
diameter D: between 10 and 30 mm, in particular between 15 and 25 mm, in particular between 18 and 22 mm;
nozzle diameter D2: between 0.3 and 1.2 mm, in particular between 0.5 and 0.6 mm;
half-angle between nozzles: between 10° and 90°, in particular between 15° and 35°, in particular at least approximately 25°.

In embodiments, each of the sprayers in the set of sprayers of the aerator unit has an associated spray shaper with one or more of the following dimensions:
spray shaper length Ls: 3.5 to 4.5 mm;
spray shaper diameter Ds: 3.0 to 4.0 mm;
length/diameter ratio: 0.8 to 1.5 mm.

In embodiments, the aerator unit comprises a macro spray shaper arranged to shape a combined spray of the sprayers of the sprayer unit.

In embodiments, parameters of the macro spray shaper are one or more of the following:
macro spray shaper length Lms: between 5 and 35 mm, in particular between 10 and 20 mm, in particular at least approximately 15 mm;
macro spray shaper inner diameter Dms: between 10 and 30 mm, in particular between 15 and 25 mm, in particular between 18 and 20 mm;
macro spray shaper length/diameter ratio: between 1:2 and 2:1, preferably at least approximately 4:5.

The sprayer unit according to the third aspect is for use in an outlet, in particular in showerhead or tap, for dispensing a liquid, in particular water or a water-based mixture, comprising at least one sprayer,
the at least one sprayer comprising a set of at least two, in particular exactly two, nozzles arranged to create colliding jets of the liquid and thereby create a spray of droplets of the liquid, and
the at least one sprayer comprising an associated spray shaper for guiding the spray, the spray shaper being a cavity through which the spray passes before exiting the sprayer unit;
characterised in that the at least one sprayer comprises a laterally wider section through which the spray of droplets created by the colliding jets of the liquid passes prior to passing through the spray shaper, wherein an average radius of the laterally wider section is larger than an average radius of the spray shaper.

This has the effect of reducing the noise created by the colliding jets and the spray generated by the colliding jets. It has been shown experimentally, that in embodiments noise in the range of human hearing can be reduced by between 1 and 5 dBA.

In embodiments, the average radius of the laterally wider section is larger than 120% of the average radius of the spray shaper, in particular larger than 150%, in particular larger than 180%.

In embodiments, a length of the laterally wider section lies between 0.5 mm and a length that is equal to a length of the spray shaper,
in particular between 1 mm and 20 mm,
in particular between 2 mm and 15 mm,
in particular between 2 mm and 10 mm,
in particular between 2 mm and 5 mm.

The length of the laterally wider section and the length of the spray shaper, respectively, are measured along the direction of the spray, which corresponds to a longitudinal axis of the sprayer.

In embodiments, the sprayer unit comprises at least two sprayers, each with an associated laterally wider section, and wherein the laterally wider sections of the at least two sprayers are in fluid communication with one another.

In embodiments, the sprayer unit comprises at least three sprayers wherein the laterally wider sections of the at least three sprayers are realised by a shared cavity arranged between the nozzle set bodies and the spray shapers of the at least three sprayers.

In embodiments, the shared cavity has an essentially cylindrical shape.

In embodiments, the shared cavity has an essentially toroidal shape.

That is, the shared cavity has a ring-like shape, linking a set of sprayers that are arranged along the circumference of the ring. It has been shown experimentally, that such a toroidal cavity can result in significantly lower noise compared to a cylindrical cavity, for the same arrangement of sprayers along the circumference of a ring.

In embodiments, the at least three sprayers are arranged along the circumference of a common circle.

In embodiments, the sprayer unit comprises a first plate comprising the nozzle set bodies and nozzles of the least two sprayers, a second plate comprising the spray shapers, with one or more of the laterally wider sections being arranged between the first plate and the second plate,
in particular with the first plate and the second plate being inseparably bonded to one another.

The first plate 11a and the second plate 11b can be bonded, for example, by gluing or welding, in particular ultrasound welding of plastic material.

The invention is described mainly in the context of spraying water or a water-based mixture, and doing so in an outlet such as a tap or showerhead. However, the invention is not limited to the use in such outlets, and neither is it limited to the dispensing or spraying of water or water-based mixtures.

Further embodiments are evident from the dependent patent claims.

The subject matter of the invention will be explained in more detail in the following text with reference to exemplary embodiments which are illustrated in the attached drawings, which schematically show:

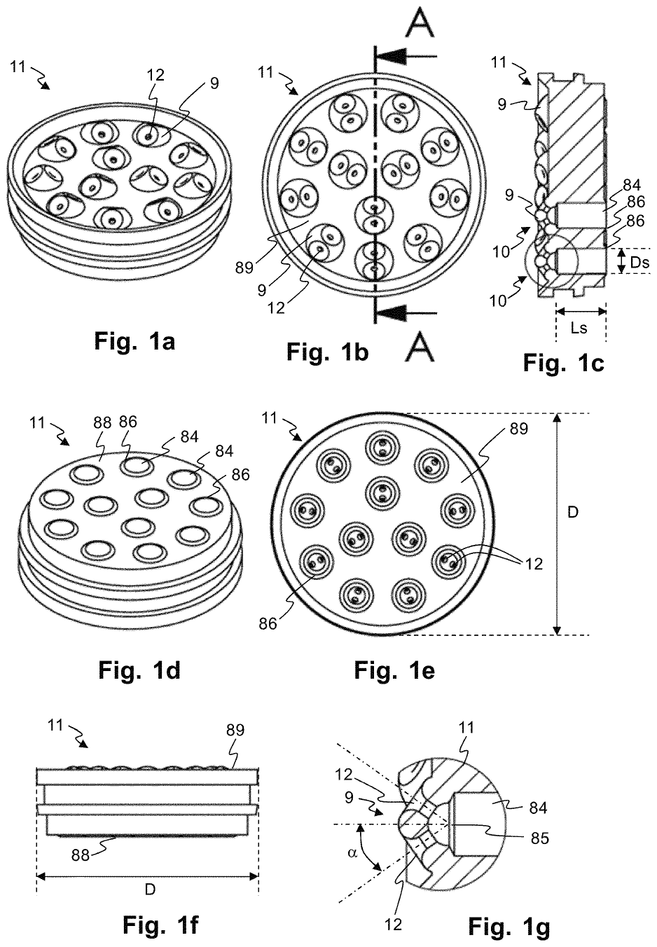

FIG. 1a-1g a first embodiment of a sprayer unit;

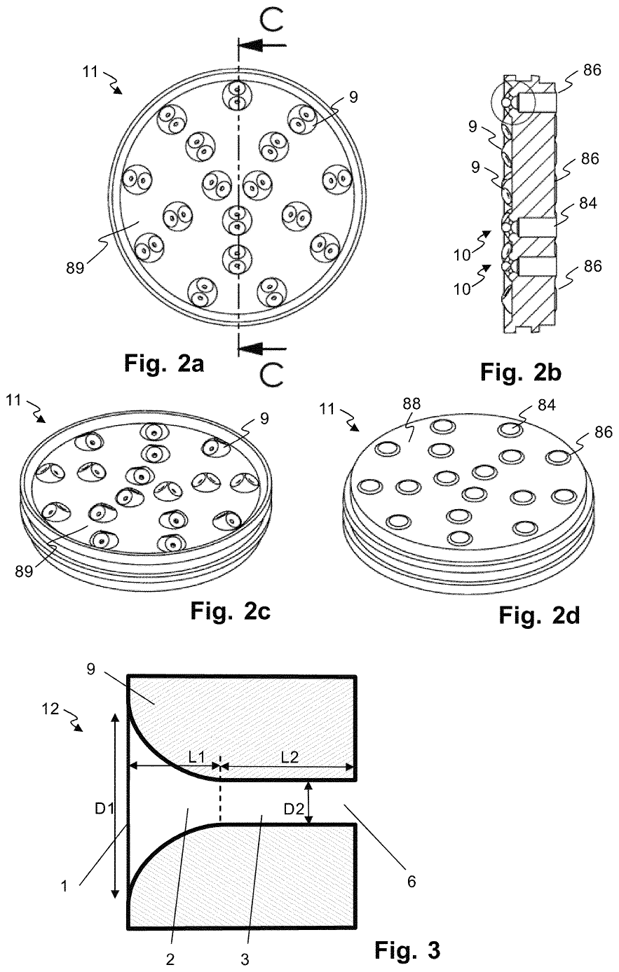

FIG. 2a-2d a second embodiment of a sprayer unit;

FIG. 3 dimensions of a nozzle;

FIG. 4a-4b a third embodiment of a sprayer unit;

FIG. 5a-5b a fourth embodiment of a sprayer unit;

FIG. 6 a fifth embodiment of a sprayer unit;

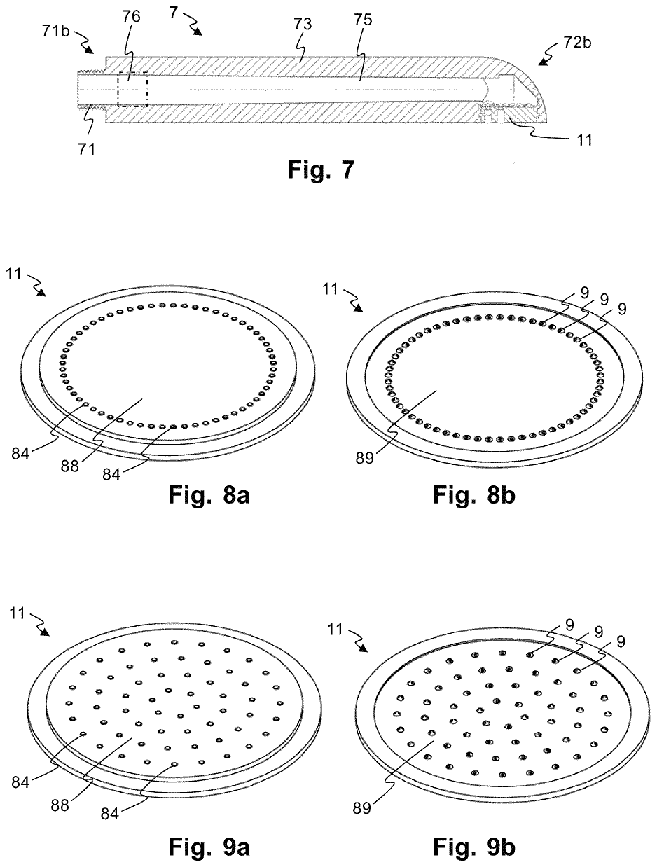

FIG. 7 an outlet with a sprayer unit;

FIG. 8a-8b a sixth embodiment of a sprayer unit;

FIG. 9a-9b a seventh embodiment of a sprayer unit;

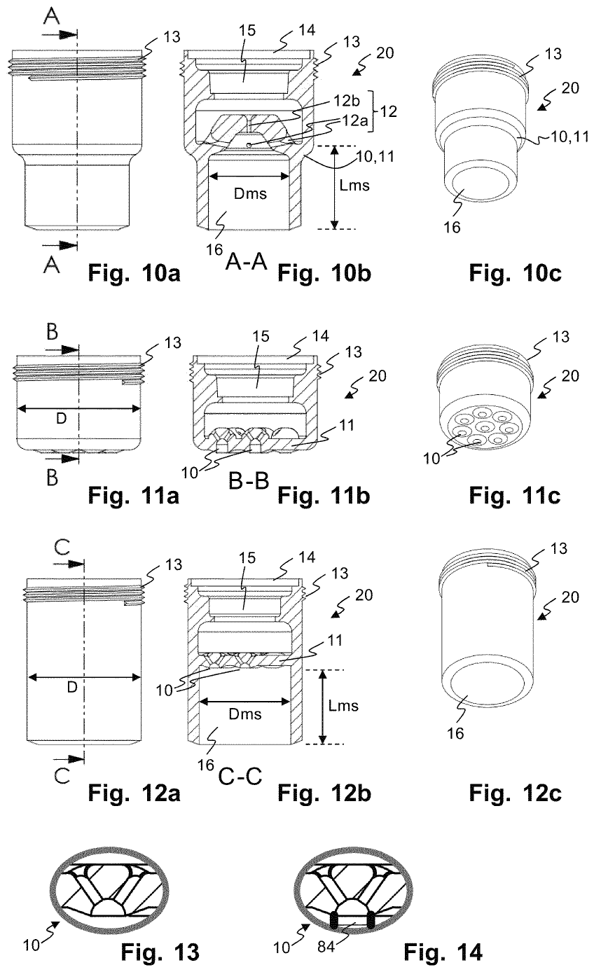

FIGS. 10a-12c aerator units;

FIG. 13 a detail of a sprayer without a spray shaper;

FIG. 14 a detail of a sprayer with a short spray shaper;

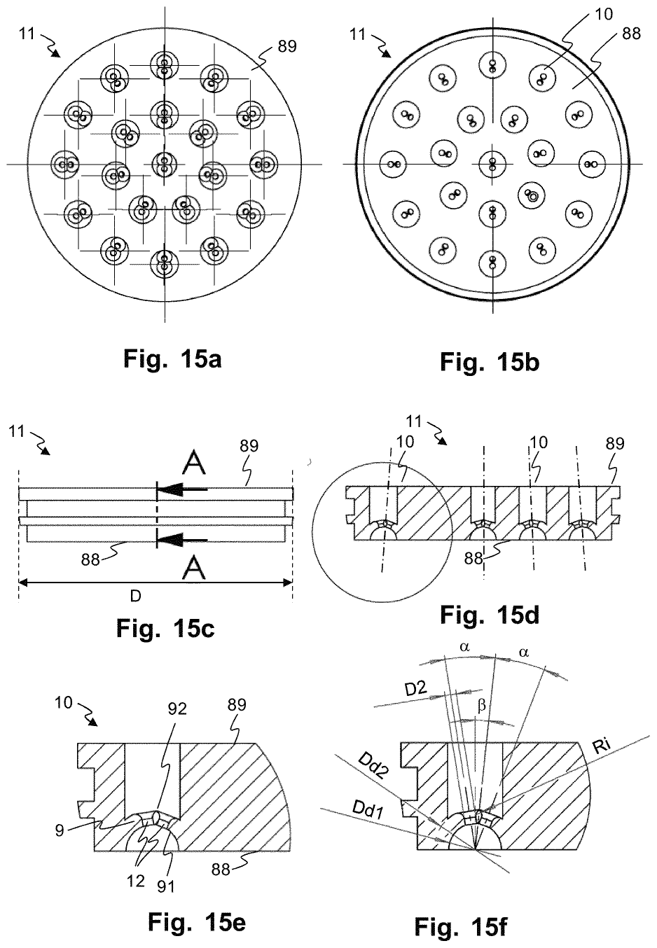

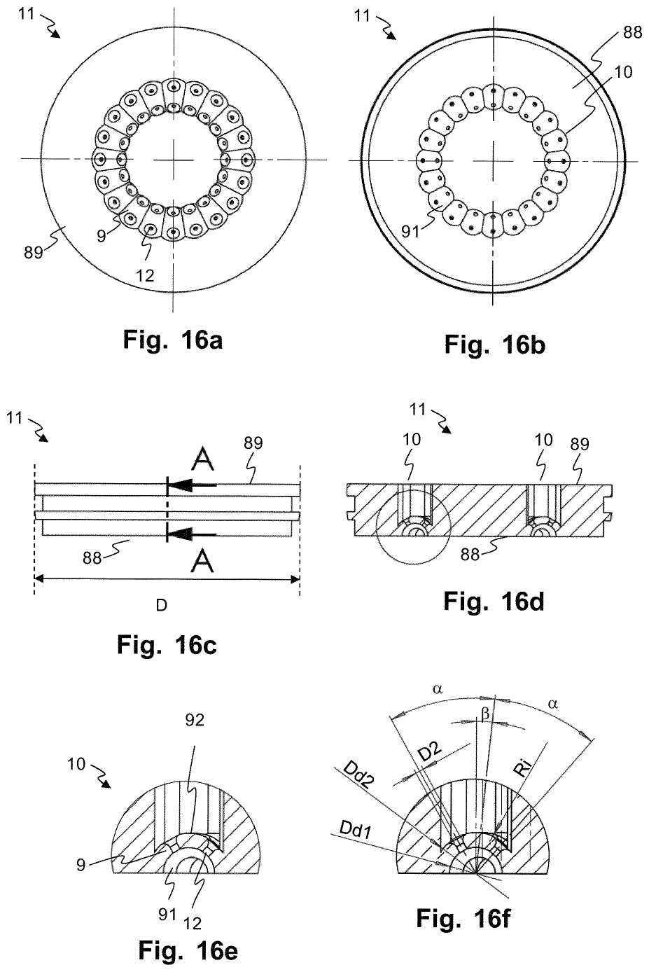

FIG. 15a-16f sprayer units without spray shapers;

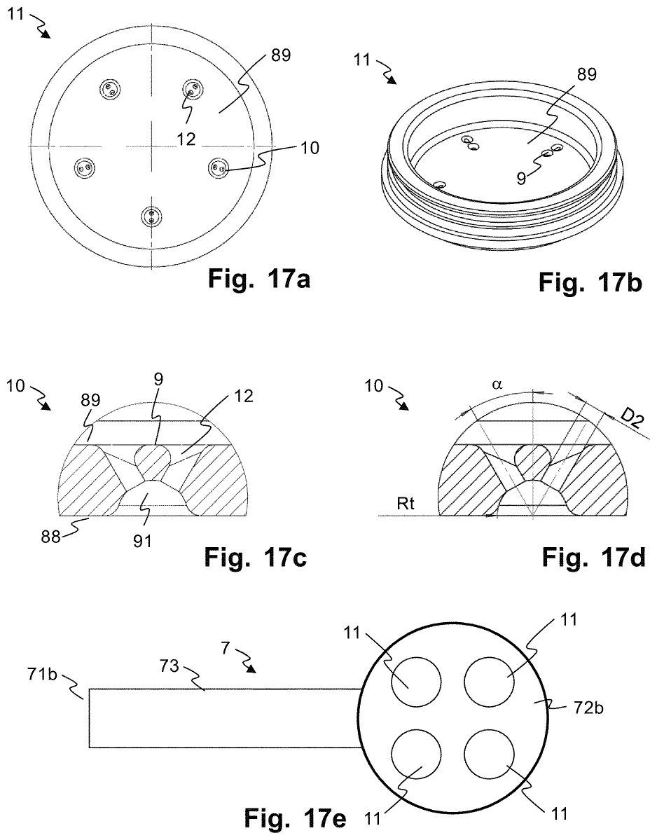

FIG. 17a-17e an outlet with multiple sprayer units, and corresponding sprayer units;

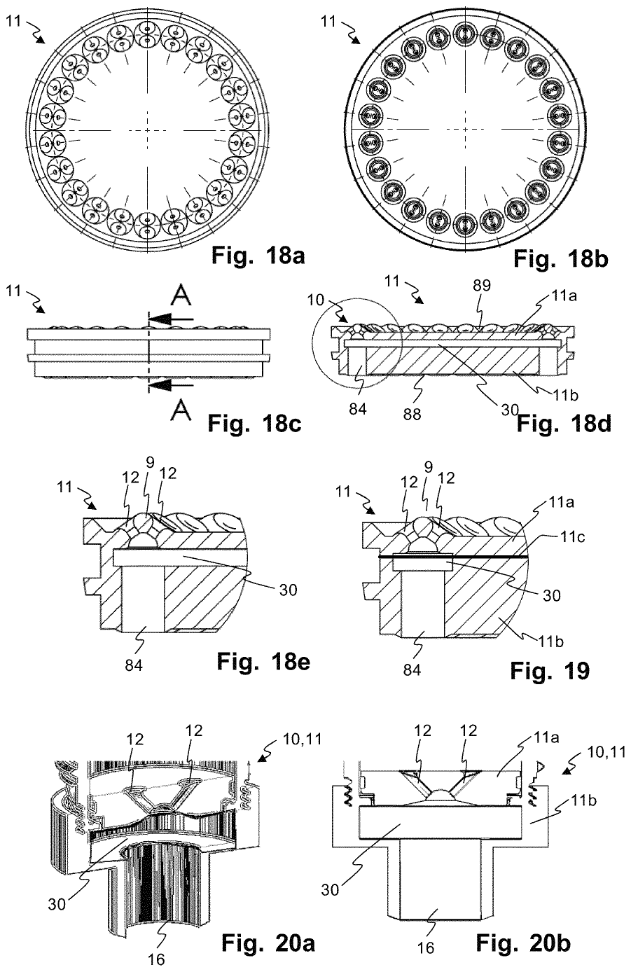

FIG. 18a-18e a sprayer unit with sprayers having a laterally wider section preceding the spray shaper;

FIG. 19 a variation thereof; and

FIG. 20a-20b a single sprayer with a laterally wider section.

In principle, identical or functionally identical parts are provided with the same reference symbols in the figures.

FIG. 1a-1g show a first embodiment of a sprayer unit 11 in different views and sectional views. The sprayer unit 11 can be used as an outlet of a showerhead or tap or other type of dispenser for liquids. It comprises a number of individual sprayers 10 shaped in a single body, typically of moulded plastic. In other embodiments, the sprayers 10 are shaped in a single body of a metal material.

The sprayer unit 11 has a generally cylindrical shape, with a generally circular front surface 88 and a back surface 89.

In each sprayer 10, the colliding jets create a spray, which is guided and shaped by a cavity, to be called spray shaper 84. The spray shaper 84 can be a cylindrical volume. At an outer end of the spray shaper 84, it terminates in a flow guiding edge 86. Seen in a longitudinal cross section, the flow guiding edge flow guiding edge 86 has an acute angle Phi1 relative to the front surface 88. This prevents the spray from adhering to the surface of the spray shaper 84 as it transitions to the front surface 88.

FIG. 1a shows a perspective view of the sprayer unit 11 from an inlet side. Approximately dome shaped nozzle set bodies 9 with inlets to nozzles 12 are each part of an individual sprayer 10. The nozzle set bodies 9 project from a back surface 89 of the sprayer unit 11. FIG. 1b shows a view towards the inlet side. FIG. 1c shows a cross section along the line A-A of FIG. 1b. It includes a cross section through individual sprayers 10, each with an associated nozzle set body 9 with nozzles 12 and a spray shaper 84, ending in a circular flow guiding edge 86. A length Ls and diameter Ds of the spray shapers 84 is shown. FIG. 1d shows a perspective view of the sprayer unit 11 from an outlet side, with a partial view into the spray shapers 84, the spray shapers 84 ending with the flow guiding edges 86. FIG. 1e shows a view towards the outlet side, including a view into the spray shapers 84 in which outlets of the nozzles 12 are visible. A diameter D is the diameter of the entire sprayer unit 11. FIG. 1f shows a side view of the sprayer unit 11. FIG. 1g shows an enlarged view of a detail from the cross section of FIG. 1c, with the nozzles 12 shaped in the nozzle set body 9. The nozzles can be shaped with the nozzle set body 9 when moulding the sprayer unit 11, or they can be shaped later by a subtractive process, e.g. by drilling. Longitudinal axes of the nozzles 12 are shown in dash-dotted lines. A half angle between the longitudinal axes is denoted α (alpha). The inner surface of the nozzle set body 9 has at least approximately the shape of a half-dome.

The diameter of this half-dome is smaller than the inner diameter D of the spray shaper 84. This allows the collision point, defined by the longitudinal axes of the nozzles 12, to be at the beginning of the spray shaper 84 while the nozzles 12 have a certain minimal length, needed to create the jet of liquid. Moving the nozzles 12 outward would increase the thickness of the sprayer 10 and the sprayer unit 11, which is undesirable.

The sprayer unit 11 of FIG. 1 has the following parameters:
diameter D: 22 mm
number of sprayers: 12
nozzle diameter D2: 0.6 mm
half-angle between nozzles: 35°
spray shaper length Ls: 5 mm
spray shaper diameter Ds: 2.5 mm

FIG. 2a-d shows a sprayer unit 11 with the same elements as the preceding one, and with the following parameters:
diameter D: 33 mm
number of sprayers: 17
nozzle diameter D2: 0.6 mm
half-angle between nozzles: 35°
spray shaper length Ls: 5 mm
spray shaper diameter Ds: 2.5 mm

FIG. 3 schematically shows main parameters describing the shape of a nozzle 12. The nozzle 12 is shaped in a nozzle set body 9 of a sprayer 10 of a sprayer unit 11 as described herein.

The nozzle 12 is arranged in the nozzle set body 9 for a liquid, typically water or a water-based mixture, to flow—in this sequence—from an inlet 1 through a converging section 2, a throat 3, and an outlet 6. After exiting the outlet 6, the liquid can flow, as a first jet of liquid, into a recess forming a spray shaper back end 85 of a spray shaper 84. There it can collide with a second jet of liquid and form a spray.

In the converging section 2, a diameter of the nozzle is reduced from a first diameter D1 to a second diameter D2. The surface can exhibit a smooth and rounded transition between the converging section 2 and the throat 3. In the embodiment shown, the surface in the converging section 2, in a radial cross section, at least approximately follows a quarter circle that runs smoothly into an outer surface of the nozzle set body 9 at one side, and smoothly into the throat 3 on the other. The converging section 2 has a first length L1. The throat 3 has a second length L2. The total length of the nozzle is the sum of L1 and L2. The total length is at least 1.5 times D2, typically the total length is two times D2.

The diameter D2 in the throat 3—generally called the diameter or the hydraulic diameter of the nozzle—corresponds to the diameter of the water jet after exiting the nozzle 12 under ideal conditions, that is, with laminar flow and no diverging of the liquid after exiting the discontinuity 5 and the nozzle outlet 6, e.g. caused by adhesion. Typical values of D2 are between 0.3 and 1.2 millimetres, in particular between 0.5 and 0.6 millimetres.

The nozzle set body 9 is typically manufactured from a plastic material that is the same as the material of the entire sprayer unit 11.

FIG. 4a-b shows a sprayer unit 11 with the same elements as the preceding ones, and with the following parameters:
diameter D: 33 mm
number of sprayers: 24
nozzle diameter D2: 0.5 mm
half-angle between nozzles: 35°
spray shaper length Ls: 5 mm
spray shaper diameter Ds: 2.5 mm

The shape of the nozzles 12 differs from the preceding embodiments in that the converging section 2 has the shape of an inner cone, leading from the outer surface of the nozzle set body 9 to the throat 3 of the nozzle 12.

With a conical shape there is a larger pressure drop at the nozzle, compared to the smooth and rounded transition of the preceding embodiments. This also reduces the flow rate through the nozzle. Conversely, a smooth and rounded converging section 2 allows for a lower pressure drop and larger flow rate. A desired flow rate can be achieved at a lower pressure, compared to a nozzle with a conical converging section 2. For all the embodiments it is the case that they can be realised with another type of converging section 2 than the one shown in the respective figures.

FIG. 5a-b shows a sprayer unit 11 with the same elements as the preceding ones, and with the following parameters:
diameter D: 50 mm
number of sprayers: 39
nozzle diameter D2: 0.6 mm
half-angle between nozzles: 35°
spray shaper length Ls: 5 mm
spray shaper diameter Ds: 2.5 mm

FIG. 6 shows a sprayer unit 11 with the same elements as the preceding ones, but with the nozzle set body of each sprayer 10 not being dome shaped but forming a flat surface that is part of a flat back surface 89 of the sprayer unit 11. This allows for an easier manufacturing process, when compared to the preceding embodiments. The nozzles 12 can comprise converging sections 2 as shown for the other embodiments.

Further embodiments of sprayer units 11 and their parameter values are:

| Embodiment | A | | B | | C | | D | |
|---|---|---|---|---|---|---|---|---|
| Number of sprayers | 17 | | 17 | | 24 | | 24 | |
| Diameter of sprayer | 33 | mm | 28 | mm | 33 | mm | 33 | mm |
| Diameter of nozzles | 0.6 | mm | 0.6 | mm | 0.5 | mm | 0.4 | mm |
| Half angle between | 35° | | 35° | | 25° | | 45° | |
| nozzles | | | | | | | | |
| Diameter of spray shaper | 2.5 | mm | 2.5 | mm | 2.5 | mm | 2.5 | mm |
| Length of spray shaper | 5 | mm | 5 | mm | 5 | mm | 5 | mm |

The table shows that when increasing the number of sprayers 10, the nozzle diameter can be reduced in order to reduce the combined flow rate, which would otherwise increase linearly with the number of sprayers 10.

FIG. 7 shows an outlet 7 for use with a sprayer unit 11 as described above. The outlet 7 comprises an outlet body 73 with a conduit 75 leading from an outlet supply section 71b with an outlet supply connector 71 to a sprayer unit connection section 72b at which the sprayer unit 11 is attached. The connection is not shown in detail, it can be made by screwing, a snap fit, glueing, welding etc. A pressure reducer 76 (shown only schematically) can be present. It reduces a pressure at the supply section 71b to a standard operating pressure of the sprayer unit 11. As a result, the flow rate through the sprayer unit 11 is largely independent of the pressure at the supply section 71b.

FIGS. 8-8b and 9-9b show embodiments of sprayer units 11 that can be used in an outlet in which the combined spray covers a larger area. For an outlet that is used as a showerhead, such an arrangement can be called rain shower. In both embodiments, the number of sprayers 10 is between 50 and 70, in particular 60. The individual sprayers 10 can have the same dimensions and nozzle shapes as those described above for the previous embodiments. The nozzle diameter in the sprayers 10 can be at the lower end of the range disclosed, e.g., 0.4 mm, in order to keep the combined flow lower. The combined flow through the 60 sprayers 10 can be between 6 litres per minute, in particular at a pressure of 0.5 bar. Thus, each sprayer 10 can have a flow rate of 0.1 litres per minute at a pressure of 0.5 bar.

A maximum diameter of the sprayer unit 11 of the two embodiments can be 160 mm. The sprayers 10 are arranged within a circular area having a diameter of less than 140 mm. In the embodiment of FIGS. 8a-8b, the sprayers 10 are arranged along a circumference of this circular area. In the embodiment of FIGS. 9a-9b, the sprayers 10 are spread out over this area.

FIGS. 10a-12c show embodiments of sprayer units 11 integrated with further elements to form a unit that can replace existing faucet aerators. Such a unit, to be called aerator unit 20, can comprise attachment elements with an external or internal thread 13 and a seating 14 for a gasket. It can further comprise a seating 15 for a pressure reducer or sieve.

The aerator unit 20 can comprise a macro spray shaper 16. The macro spray shaper 16 shapes a spray generated by the aerator unit 20 as a whole. So, the aerator unit 20 forms an integrated unit comprising attachment elements and one or more sprayers 10.

FIGS. 10a-10c show an embodiment in which a spray generated by the aerator unit 20 is generated by a single sprayer 10. That is, there is a single set of nozzles 12. creating impinging jets.

The set of nozzles 12 can comprise two, three, four or five or six nozzles 12 creating jets colliding in the same point. One group of peripheral nozzles 12a can be arranged with their axes at essentially the same angle to a longitudinal axis of the sprayer 10. These peripheral nozzles 12a all can have the same diameter. In embodiments, a further, central nozzle 12b is present. It is coaxial with the longitudinal axis of the sprayer 10. The diameter of the central nozzle 12b can be the same as that of the peripheral nozzles 12a. In embodiments, the diameter of the central nozzle 12b is smaller than 90% or 80% or 70% or 60% or 50% of the diameter of the peripheral nozzles 12a. In embodiments, the diameter of the central nozzle 12b is larger than 110% or 120% or 130% or 140% or 150% of the diameter of the peripheral nozzles 12a. This difference in diameter has been found to reduce the noise generated by the impinging jets.

In embodiments, the aerator unit 20 of FIGS. 10a-10c has the following parameters:
diameter of the peripheral nozzles 12a: between 0.6 and 1 mm, in particular between 0.7 and 0.9 mm, in particular at least approximately 0.8 mm.
diameter of the central nozzle 12b: between 55% and 95%, in particular between 65% and 85%, in particular at least approximately 75% of the diameter of the peripheral nozzles 12a.
half-angle between the peripheral nozzles: between 60° and 100°, in particular between 70° and 90°, in particular at least approximately 80°.
macro spray shaper length Lms: between 5 and 35 mm, in particular between 10 and 20 mm, in particular at least approximately 15 mm.
macro spray shaper inner diameter Dms: between 10 and 20 mm, in particular between 12 and 17 mm, in particular between 13 and 14 mm.

FIGS. 11a-11c show an embodiment in which a spray generated by the aerator unit 20 is generated by multiple sprayers 10, each sprayer 10 having its own associated spray shaper 84.

FIGS. 12a-12c show an embodiment in which a spray generated by the aerator unit 20 is generated by multiple sprayers 10, with a single macro spray shaper 16 shaping the combined spray of the multiple sprayers 10.

In embodiments, the aerator units 20 of FIGS. 11a-11c and FIGS. 12a-12c have the following parameters:
diameter D: between 10 and 30 mm, in particular between 15 and 25 mm, in particular between 18 and 22 mm.
number of sprayers: between 2 and 15, in particular between 5 and 9, in particular 7.
nozzle diameter D2: between 0.3 and 1.2 mm, in particular between 0.5 and 0.6 mm.
half-angle between nozzles: between 10° and 90°, in particular between 15° and 35°, in particular at least approximately 25°.

In embodiments, the sprayers 10 of the aerator units 20 of FIGS. 11a-11c have associated (micro) spray shapers 84 with the following dimensions:
spray shaper length Ls: between 1 and 4 mm
spray shaper (inner) diameter Ds: between 0.5 and 4 mm
length/diameter ratio: between 0.5 and 2.

In embodiments, the sprayers 10 of the aerator units 20 of FIGS. 12a-12c have no associated (micro) spray shapers 84. That is, the spray of each of the sprayers 10, after the collision point of the jets, is not constrained by an individual spray shaper 84 of that sprayer 10. This is shown in FIG. 13.

In embodiments, the sprayers 10 of the aerator units 20 of FIGS. 12a-12c have relatively short (micro) spray shapers 84. In embodiments, the spray shaper length Ls: is between 0.5 and 1.5 mm. This is shown in FIG. 14. Their inner diameter can be between 0.5 mm and 4 mm.

In embodiments, the macro spray shaper 16 of the aerator unit 20 of FIGS. 12a-12c has the following parameters:
macro spray shaper length Lms: between 5 and 35 mm, in particular between 10 and 20 mm, in particular at least approximately 15 mm.
macro spray shaper inner diameter Dms: between 10 and 30 mm, in particular between 15 and 25 mm, in particular between 18 and 20 mm.
macro spray shaper length/diameter ratio: between 1:2 and 2:1, preferably at least approximately 4:5.

As in all the embodiments, in each of the sprayers the number of nozzles can lie between two and five. In particular it can be two or four.

FIGS. 15a-15f show a sprayer unit 11 without spray shapers, in different views. FIG. 15d is a sectional view in the plane A-A indicated in FIG. 15c. FIG. 15e is a detail view of part of FIG. 15d. FIG. 15f is the same, showing dimensions.

The arrangement of sprayers 10 in the plane of the sprayer unit 11 can be as in any of the embodiments of the FIGS. 1 to 9. However, the spray shapers are not present. The point of collision of the jets, defined by the intersection of the longitudinal axes of the nozzles 12, lies approximately near or forward of the front surface 88. The spray created by the collided jets does not interact with a solid body that is part of the sprayer unit 11, as would be the case if a spray shaper 84 were present. In each sprayer 10, the nozzles 12 are arranged in the nozzle set body 9 that forms at least approximately part of a dome, with a dome inner surface 91 facing the direction of the spray, and a dome outer surface 92 facing the opposite direction, that is, the same direction as the back surface 89.

The sprays generated by the sprayers 10 combine to form a combined spray of the sprayer unit 11. In order to achieve a wider shape of the combined spray, the multiple sprayers are not oriented in the same direction. Instead, at least sprayers 10 at the periphery of the sprayer unit 11 are angled, with an offset angle β of the longitudinal axis of the respective sprayers 10 relative to a main longitudinal axis of the sprayer unit 11, so that the longitudinal axes of these sprayers diverge from the main longitudinal axis.

In embodiments, sprayer units 11 according to FIGS. 15a-15f have one or more of the following parameters:
diameter D: between 10 and 50 mm, in particular between 10 and 30 mm, in particular between 25 and 35 mm.
number of sprayers: between 5 and 30, in particular between 10 and 20.

In embodiments, sprayers 10 according to FIGS. 15a-15f have one or more of the following parameters:
nozzle diameter D2: between 0.4 and 1 mm, in particular between 0.6 and 0.8 mm.
half-angle α between nozzles: between 5° and 55°, in particular between 15° and 35°, in particular at least approximately 25°.
offset angle β of peripheral nozzles: between 2° or 4° and 10°, in particular between 5° and 7°, in particular at least approximately 6°.

A diameter of the dome inner surface 91 can be approximately 3 mm. A diameter of the dome outer surface 92 can be approximately 5 mm. A radius of a transition surface in the converging section 2 between the dome outer surface 92 and the throat 3 of each nozzle 12 can be approximately 0.4 mm.

FIGS. 16a-16f show a sprayer unit 11 without spray shapers in different views. FIG. 16d is a sectional view in the plane A-A indicated in FIG. 16c. FIG. 16e is a detail view of part of FIG. 16d. FIG. 16f is the same, showing dimensions.

A plurality of sprayers 10 is arranged along the circumference of a circle. The sprayers 10 can be so close to one another that their dome inner surfaces 91 overlap. In this case, a continuous groove is formed along the circumference of the circle, as seen in the detail view of FIG. 16e.

The sprays generated by the sprayers 10 combine to form a combined spray of the sprayer unit 11. In order to achieve a wider shape of the combined spray, the multiple sprayers are angled, with an offset angle β relative to a main longitudinal axis of the sprayer unit 11, so that the longitudinal axes of these sprayers diverge from the main longitudinal axis. The continuous groove also makes the sprayer unit easier to manufacture.

In embodiments, sprayer units 11 according to FIGS. 16a-16f have one or more of the following parameters:
diameter D: between 10 and 50 mm, in particular between 10 and 30 mm, in particular between 25 and 35 mm.
number of sprayers: between 5 and 30, in particular between 10 and 20.
diameter of the ring of sprayers 10: between 10 and 25 mm, in particular between 12 and 20 mm, in particular between 14 and 18 mm.

In embodiments, sprayers 10 according to FIGS. 16a-16f have one or more of the following parameters:
nozzle diameter D2: between 0.2 and 0.8 mm, in particular between 0.4 and 0.6 mm.
half-angle α between nozzles: between 15° and 50°, in particular between 30° and 40°, in particular at least approximately 35°.
offset angle β of the nozzles: between 2° or 4° and 10°, in particular between 5° and 7°, in particular at least approximately 6°,

A diameter of the dome inner surface 91 can be approximately 3 mm. A diameter of the dome outer surface 92 can be approximately 5 mm. A radius of a transition surface in the converging section 2 between the dome outer surface 92 and the throat 3 of each nozzle 12 can be approximately 0.4 mm.

FIGS. 17a-17e show in FIG. 17e an outlet 7 with multiple sprayer units 11, and corresponding sprayer units in FIG. 17a-b, with details of nozzles in FIG. 17c and dimensions thereof in FIG. 17d. The outlet 7 comprises an outlet body 73 that can be used as a handle, with a conduit leading from an outlet supply section 71b with an outlet supply connector to a sprayer unit connection section 72b or showerhead. The showerhead comprises two or more sprayer units 11, each with a set of sprayers 10. The sprayer units 11 can be attached to the showerhead, for example, by screwing, a snap fit, glueing, welding etc.

In embodiments, sprayer units 11 according to FIGS. 17a-17e have one or more of the following parameters:
diameter D: between 10 and 50 mm, in particular between 15 and 35 mm, in particular between 20 and 30 mm.
number of sprayers: between 3 and 20, in particular between 4 and 10.

In embodiments, sprayers 10 according to FIGS. 17a-17e have one or more of the following parameters:
nozzle diameter D2: between 0.2 and 0.8 mm, in particular between 0.4 and 0.5 mm.
half-angle α between nozzles: between 15° and 50°, in particular between 25° and 35°, in particular at least approximately 30°.

A radius Rt of a transition between the dome inner surface 91 and the front surface 88 can be approximately 0.75 mm.

FIGS. 18a-18e show a sprayer unit 11 unit with sprayers having a laterally wider section 30 preceding the spray shaper.

The arrangement of sprayers 10 in the plane of the sprayer unit 11 can be as in any of the embodiments of the FIGS. 1 to 9. However, following (seen along the direction of the flow) the point of collision of the jets, defined by the intersection of the longitudinal axes of the nozzles 12, lies a laterally wider section 30. This laterally wider section 30 is wider than the subsequent spray shaper. A part of the acoustic energy generated by the collision of the jets is absorbed or dissipated in the laterally wider section 30. As a result, the noise generated by the sprayers 10 is reduced.

Such a laterally wider section 30 can be present separately in each of the sprayers 10. Alternatively, the laterally wider sections 30 of two or more sprayers 10 can overlap, forming a shared hollow space in the sprayer unit 11. FIG. 18d with a detail in FIG. 18e show an embodiment in which a ring of sprayers 10 is present. A cylindrical laterally wider section 30 is present, with the sprayers 10 at the periphery of the laterally wider section 30. In embodiments not shown, further sprayers 10 are present within the area of the laterally wider section 30, not only at its periphery. FIG. 19 shows an embodiment in which not the entire surface of the sprayer unit 11 is covered by the laterally wider section 30, but wherein only a toroidal laterally wider section 30 runs along the circle on which the sprayers 10 are arranged. Surprisingly, this arrangement has better acoustical properties than that of FIG. 18d-18e.

FIG. 19 also shows a possible structure for manufacturing the sprayer unit 11, that is, by combining a first plate 11a with the nozzle set bodies 9 and a second plate 11b with the spray shapers 84, joined at a contact surface 11c, with the laterally wider section 30 defined by recesses in the first plate 11a and/or second plate 11b.

FIGS. 20a-20b show a sprayer unit 11 comprising a single sprayer 10 with a laterally wider section. Two parts 11a and second plate 11b between which the laterally wider section 30 is formed are joined by a screw joint. In other embodiments, they can be joined by glueing or welding.

While the invention has been described in present embodiments, it is distinctly understood that the invention is not limited thereto, but may be otherwise variously embodied and practised within the scope of the claims.

1-28. (canceled)

29. An Outlet comprising:
an outlet body with a conduit leading from a supply section to a connection section, and
at least two sprayer units attached to the connection section, each sprayer unit comprising a set of sprayers, each sprayer comprising a set of at least two nozzles arranged to create colliding jets of the liquid and thereby create a spray of droplets of the liquid, wherein the number of sprayers in the set of sprayers is at least two.

30. The outlet according to claim 29, each sprayer unit being attached to the connection section by one of screwing, snap fit, glueing and welding.

31. The outlet according to claim 29, wherein the number of the sprayers in the set of sprayers is at least five.

32. The outlet according to claim 29, each sprayer comprising a set of exactly two nozzles.

33. The outlet according to claim 29, comprising at least three sprayer units.

34. The outlet according to claim 29, the number of sprayers per sprayer unit ranging from 3 to 20.

35. The outlet according to claim 29, wherein a diameter of the sprayer unit is less than five centimetres.

36. The outlet according to claim 29, wherein a diameter of the sprayer unit is less than three centimetres.

37. The outlet according to claim 29, wherein a diameter of the sprayer unit ranges from 20 to 30 mm.

38. The outlet according to claim 29, wherein the sprayers of the set of sprayers are formed as a single part comprising a single component or comprising two or more components moulded together.

39. The outlet according to claim 29, the sprayers of a sprayer unit having a same dimension.

40. The outlet according to claim 29, the sprayers of a sprayer unit being oriented in a same direction.

41. The outlet according to claim 29, the nozzles of each sprayer of the set of sprayers being exactly two and having their axes contained in a plane oriented radially with respect to a longitudinal axis of the spray unit.

42. The outlet according to claim 29, each sprayer comprising an associated spray shaper for guiding the spray, the spray shaper being a cavity through which the spray passes before exiting the sprayer unit.

43. The outlet according to claim 42, each sprayer being arranged in a dome shaped structure covering the spray shaper of the sprayer, with an inner surface of the dome shaped structure having a smaller diameter than a diameter of the spray shaper.

44. The outlet according to claim 43, the inner surface of the dome shaped structure having a diameter of less than 80% of the diameter of the spray shaper.

45. The outlet according to claim 42, wherein in each of the sprayers a distance between a point at which the jets collide and an outlet opening of the spray shaper, this distance to be called length of the spray shaper, lies between three and twenty millimetres.

46. The outlet according to claim 45, the length of the spray shaper lying between three and seven millimetres.

47. The outlet according to claim 42, wherein an inner diameter of the spray shaper lies between one and a half and four millimetres.

48. The outlet according to claim 29, wherein in each of the sprayers the diameter of the nozzles lies between 0.3 and 1.2 millimetres.

49. The outlet according to claim 29, wherein in each of the sprayers the diameter of the nozzles lies between 0.2 and 0.8 millimetres.

50. The outlet according to claim 29, wherein in each of the sprayers a half-angle between colliding jets lies between 15 and 50 degrees.

51. The outlet according to claim 29, being a showerhead.
